(19) United States
(12) Patent Application Publication
(10) Pub. No.: US 2019/0225763 A1
(43) Pub. Date: Jul. 25, 2019

(54) BIOPLASTIC FILM, BUBBLE FILM, AND BUBBLE FILM PRODUCT USING SAME

(71) Applicant: CJ CHEILJEDANG CORPORATION, Seoul (KR)

(72) Inventors: Eun Jin PARK, Seoul (KR); Hye Min CHOI, Seoul (KR); Sang Gwon MOON, Seoul (KR)

(73) Assignee: CJ Cheiljedang Corporation, Seoul (KR)

(21) Appl. No.: 16/314,530

(22) PCT Filed: Jun. 28, 2017
(86) PCT No.: PCT/KR2017/006848

§ 371 Date: Dec. 31, 2018

(30) Foreign Application Priority Data
Jul. 1, 2016 (KR) 10-2016-0083392
Feb. 10, 2017 (KR) 10-2017-0018595

(51) Int. Cl. C08J 5/18; C08L 23/06; B32B 3/12; B32B 5/02; B32B 7/12; B32B 27/10; B32B 27/32; B32B 27/20; B65D 81/03

(52) U.S. Cl. CPC C08J 5/18; B32B 2264/10; B32B 3/12; B32B 5/022; B32B 7/12; B32B 27/10; B32B 27/32; B32B 27/20; B65D 81/03; C08J 2323/06; C08J 2423/06; C08L 2205/025; C08L 2203/16; B32B 2553/026; B32B 2264/06; C08L 23/06

(57) ABSTRACT

The present application relates to: a bioplastic film comprising wheat husk which is a food by-product; a bubble film; and a bubble film product using the same.

### TECHNICAL FIELD

The present disclosure relates to a bioplastic film including wheat bran which is a food by-product, a bubble film, and a bubble film product using the same.

### BACKGROUND ART

In order to prevent parcels from being damaged during parcel delivery services, parcels are packaged. In the case of parcel packaging for clothes, 1) a method of packing clothes with a hanger-type suitcase made of a non-woven fabric, 2) a method of performing primary transparent polyvinyl packaging and then putting the package in a box, and 3) a method of performing primary transparent polyvinyl packaging and then performing non-transparent polyvinyl packaging are widely used.

Particularly, 1) the method of packing clothes with a hanger-type suitcase made of a non-woven fabric is mainly used for clothes that should not be creased, such as coats or suits, and the package is delivered in the form of a hanger-type suitcase. In this packaging method, a PET-based non-woven fabric material, as a packaging material, is processed into the suitcase form, and then the outer packaging is completed by attaching a transparent film so as to facilitate checking of the clothes and attachment of a tracking label.

2) The method of putting a package in a box or 3) the method of performing non-transparent polyvinyl packaging is applicable to clothes that do not easily creased. In terms of cost, the method of putting a package in a box or 3) the method of performing non-transparent polyvinyl packaging is more than 60% cheaper than the method of using a hanger-type suitcase, because products are packaged after being folded.

With the recent rapid growth of online shopping, parcel delivery services for delivering purchased goods have also increased greatly, resulting in an exponential increase in the use of packaging materials for parcels. Specifically, as in Korean Patent Publication No. 10-2016-0029271, in which films made of low-density polyethylene are used in plain films and embossed films, and Korean Unexamined Utility Model No. 20-2013-0006038, in which a plane base sheet film molded using high-density polyethylene is pressurized/molded on one surface of an embossed cap sheet embossed with low-density ethylene, known parcel packaging materials are made of petroleum-derived plastic products. The used parcel packaging materials are not easily recycled, and when incinerated or deposited in landfills, they generate toxic gas, causing air pollution, and as a consequence, landfill space is limited and environmental contamination occurs.

To solve this problem, there have been attempts to develop and utilize plastic compositions including plant-derived by-products. However, there are problems in that their physical properties such as elongation, tensile strength, etc. are deteriorated, as compared with known plastic compositions, and existing facilities may not be used.

Until now, there has been a demand for a bio-plastic film that does not have deteriorated physical properties while solving environmental pollution problems, and a bubble film product using the same.

### PRIOR ART DOCUMENTS

(Patent Document 1) KR10-2016-0029271 A1

(Patent Document 2) KR20-2013-0006038 U1

### DESCRIPTION OF EMBODIMENTS

### Technical Problem

An object of the present disclosure is to provide a bioplastic film and a bubble film, each including a plastic composition composed of a plant-derived by-product in order to solve environmental pollution problems, wherein physical properties of the bioplastic film and the bubble film are not deteriorated, as compared with known petroleum-derived plastic products.

Further, another object of the present disclosure is to provide a bubble film product including the bubble film and a subsidiary material.

### Solution to Problem

In order to solve the above problems, the present disclosure provides a bioplastic film including a first polyolefin-based resin, a wheat bran-containing composition, and a desiccant.

Here, the first polyolefin-based resin may be one or more selected from polyethylene (PE), polypropylene (PP), polybutylene, and polymethylpentene, and may be polyethylene (PE). The polyethylene (PE) may be one or more selected from linear low-density polyethylene (LLDPE), low-density polyethylene (LDPE), and high-density polyethylene (HDPE). The first polyolefin-based resin may be included in an amount of 85% by weight to 95% by weight based on the total weight of the bioplastic film. Other than the above kind and range, physical properties of the bioplastic film may become uneven.

The wheat bran-containing composition may be included in an amount of 2% by weight to 8% by weight based on the total weight of the bioplastic film, and the wheat bran-containing composition may include a second polyolefin-based resin, wheat bran, a wax, an inorganic filler, and a surfactant.

Specifically, the second polyolefin-based resin may be one or more selected from polyethylene (PE), polypropylene (PP), polybutylene, and polymethylpentene, may be one or more selected from polyethylene (PE) and polypropylene (PP), and may be polyethylene (PE). More specifically, the polyethylene may be one or more selected from linear low-density polyethylene (LLDPE), low-density polyethylene (LDPE) and high-density polyethylene (HDPE). Further, the polyethylene may be reacted in the presence of one or more catalysts selected from a metallocene catalyst and a Zeigler-Natta catalyst, and may be reacted in the presence of the metallocene catalyst. Unlike the Ziegler-Natta catalyst, the metallocene catalyst has a single active site, and therefore, the single-site catalyst technology may be employed to control a polymer structure precisely, thereby freely realizing a specific synthetic process. Particularly, M-PE refers to PE which is synthesized in the presence of the metallocene catalyst. M-PE is superior in processability and quality to other PEs.

Further, the second polyolefin-based resin may be included in an amount of 40% by weight to 70% by weight based on the total weight of the wheat bran-containing composition. When the content is less than 40% by weight, there are problems that mixing of the composition may not be easy and physical properties may not be even at the time of manufacturing films. When the content is more than 70% by weight, the composition may not maintain a unique color of the wheat bran and carbon reduction effect may appear insignificant. However, since the composition of the present disclosure includes the polyolefin-based resin within the above range, the composition may maintain the unique color of the wheat bran, may form no bubble of the wheat bran at the time of manufacturing films, and may secure appearance and quality the same as those of the existing plastic films.

Meanwhile, the wheat bran may be, among the biomass, by-products left after production of wheat powder. Specifically, a size of the wheat bran may be 5 μm to 30 μm, and may be 10 μm to 25 μm. When the size of the wheat bran is less than the above range, the powder tends to fly to deteriorate the workability, which adversely affects the yield. When the size of the wheat bran is more than the above range, a melting index (MI) of the composition may increase to cause non-uniform hardness of pellets which are prepared using the composition, and thus may deteriorate film processability at the time of manufacturing a film using the composition, thereby generating holes or deviation of physical properties (e.g., sealing strength, tensile strength, elongation, etc.) of the film.

A polydispersity index (PDI) of the wheat bran may be 2 or less, and may be 1.5 or less. PDI indicates particle uniformity, and is defined as the square of the standard deviation of diameter/mean diameter. When PDI of the wheat bran is above the range, physical properties of the wheat bran-containing composition may not be uniform and dispersity may deteriorate.

Further, the wheat bran may have a water content of 1% to 10%. The water content of the wheat bran is below the range, processing of the wheat bran may be inefficient. The water content of the wheat bran is above the range, the composition prepared using the wheat bran may have poor physical properties, and processability of the film may deteriorate.

The wheat bran may be included in an amount of 10% by weight to 30% by weight based on the total weight of the wheat bran-containing composition. When the content is less than the above range, the wheat bran-containing composition may not exhibit a unique color of the wheat bran. When the content is more than the above range, the wheat bran of a small size agglomerate together to form bubbles during preparation of the wheat bran-containing composition, which possibly creates holes at the time of manufacturing a bioplastic film using the wheat bran-containing composition, or deteriorates physical properties (e.g., sealing strength, tensile strength, elongation, etc.) of the manufactured bioplastic film. However, the wheat bran-containing composition of the present disclosure, having the above content range of the wheat bran, may maintain the unique color of the wheat bran, may form no bubble during the manufacture of the bioplastic film, and may provide appearance and quality the same as those of the existing petroleum-derived films.

The wax serves to connect the wheat bran with the polyolefin resin. The wax may include, but is not limited to, one or more selected from paraffin wax, liquid paraffin wax, beeswax, montan wax, candelilla wax, polyethylene wax, and polypropylene wax. The wax may be polyethylene wax. The wax may be low-density polyethylene (LDPE) wax and high-density polyethylene (HDPE) wax, which may be used alone or in a mixture thereof. The wax may be included in an amount of 10% by weight to 20% by weight based on the total weight of the wheat bran-containing composition.

The inorganic filler may be, but is not limited to, one or more selected from the group consisting of calcium carbonate, silica, mica, and talc. The inorganic filler may be calcium carbonate (CaCO₃) that is inexpensive. The inorganic filler may be included in an amount of 5% by weight to 20% by weight based on the total weight of the wheat bran-containing composition. When the content of the inorganic filler is less than the above range, physical properties may deteriorate and production costs may increase. When the content of the inorganic filler is more than the above range, physical properties of the wheat bran-containing composition and the bioplastic film may deteriorate.

The surfactant of the present disclosure serves to form a coating on the surface of the wheat bran, to mix well the wheat bran with the wax or the polyolefin resin, and to prevent the wheat bran from being burnt. The surfactant may be, but is not limited to, one or more selected from fatty acids, such as stearic acid, myristic acid, palmitic acid, arachidic acid, oleic acid, linoleic acid, and hard fatty acids, and polyols, such as glycerin, butylene glycol, propylene glycol, dipropylene glycol, pentylene glycol, hexylene glycol, polyethylene glycol, and sorbitol. The surfactant may be included in an amount of 0.5% by weight to 5% by weight based on the total weight of the wheat bran-containing composition. When the content of the surfactant is less than 0.5% by weight, the effects of the surfactant may be insignificant. When the content of the surfactant is more than 5% by weight, physical properties of the bioplastic film, such as tensile strength, etc. may deteriorate.

The desiccant may be zeolite, silica gel, activated alumina, etc., but they may be used without limitation. The desiccant may absorb water in the wheat bran-containing composition to prevent bubble generation at the time of manufacturing the film. In particular, when the bioplastic film is molded into a bubble film, bubble generation may be prevented by adding the desiccant, thereby preventing production of defectives. The desiccant may be included in an amount of 3% by weight to 8% by weight based on the total weight of the biofilm. When the content of the desiccant is less than the above range, functions of the additive may not be manifested. When the content of the desiccant is more than the above range, physical properties of the bioplastic film may not be maintained.

The bioplastic film may have physical properties that may replace the known petroleum-derived plastic films. Specifically, the bioplastic film may have sealing strength of 0.7 kgf to 1.0 kgf and puncture strength of 0.13 kgf to 0.19 kgf.

Further, the bioplastic film may be manufactured by a method of manufacturing a bioplastic film, the method including 1) mixing the first polyolefin resin with the wheat bran-containing composition, 2) further mixing with the desiccant, and 3) extruding the mixture using a T-die extruder to manufacture the bioplastic film.

The present disclosure provides a bubble film including the bioplastic film.

The bubble film may have sealing strength of 1.5 kgf to 2.1 kgf and pressure-resistant strength of 0.05 kgf to 0.07 kgf.

Further, the bubble film may be manufactured by a method of manufacturing a bubble film, the method including 1) mixing the first polyolefin resin with the wheat bran-containing composition, 2) further mixing with the desiccant, 3) extruding the mixture using a T-die extruder to manufacture the bioplastic film, and 4) forming the bubble film from the bioplastic film. Specifically, the forming of the bubble film may be performed by passing a first bioplastic film 111 and a second bioplastic film 112 at the same time through a bubble film-molding roll to manufacture the bubble film 110 (see FIG. 5).

The present disclosure provides a bubble film product 100 which is a laminate of the bubble film 110 and a subsidiary material 130.

The subsidiary material 130 may include one or more subsidiary materials selected from paper, a film, a foam, and a non-woven fabric. Specifically, the paper may be Kraft paper, traditional Korean paper, or polyethylene-coated Kraft paper or traditional Korean paper. The film may be one or more selected from nylon, cellophane, cellulose, ethylene vinyl acetate, polyvinyl chloride, polyvinylidene chloride, polycarbonate, polyamide, polyvinyl alcohol, polyurethane, an acrylic resin, polyethylene terephthalate, polyethylene, polypropylene, polybutylene, and polymethylpentene, and a printed film may be also used. The foam may be polyurethane, polystyrene, a phenol resin, polyvinyl chloride, polyethylene, polypropylene, polybutylene, or polymethylpentene. The non-woven fabric may be any one selected from polyethylene, polypropylene, polybutylene, polymethylpentene, and polyethylene terephthalate, but is not limited thereto.

The bubble film 110 and the subsidiary material 130 may be laminated by an adhesive layer 120 which is formed by an adhesive material. Specifically, the adhesive material may be a known adhesive.

Further, the bubble film product may be used in a packaging material, a wallpaper, a floor material, a mat, a heat insulating cover, an interior material, a sculpture, and clothing by using its buffering, insulating, and sound-proofing functions. Specifically, the packaging material may be a packaging bag or a packaging box, and the mat may be a rug, and the clothing may be any one selected from clothes, socks, and hats.

For example, when Kraft paper or polyethylene-coated Kraft paper is used as the subsidiary material of the bubble film product of the present disclosure, the bubble film product may be a Kraft bubble film cloth packaging material for parcel delivery services (see FIG. 7A). The bubble film product may replace box packaging, because the bubble film as a cushioning material absorbs impact while the Kraft paper enduring the impact during parcel distribution. Further, since the cushioning material enables the packaging to maintain its shape, clothes may be transported in the form of a hanger while being unfolded, thereby preventing creases and manufacturing the bubble film product at a cost of 30% lower than that of a known non-woven fabric suitcase.

For another example, when traditional Korean paper or polyethylene-coated traditional Korean paper is used as the subsidiary material of the bubble film product, the bubble film product of the present disclosure may be traditional Korean paper bubble film cloth packaging material for parcel delivery services (see FIG. 7B). When the traditional Korean paper is used as the subsidiary material, it is possible to provide a luxurious parcel package due to the luxurious image of traditional Korean paper, and the bubble film as a cushioning material absorbs impact which may be generated during parcel distribution, and therefore, the bubble film product may replace a box or a non-transparent plastic bag packaging. Furthermore, since the cushioning material enables the packaging to maintain its shape, clothes may be transported in the form of a hanger while being unfolded, thereby preventing creases and manufacturing the bubble film product at a cost of 20% lower than that of a known non-woven fabric suitcase.

For still another example, when a printed film is used as the subsidiary material of the bubble film product, the bubble film product may be a bubble film cloth packaging material for parcel delivery services, which maintains packaging configuration (see FIG. 7C). It is possible to promote the contents printed on the surface. Since this bubble film product is light in weight, it is suitable for packaging for parcel delivery services, and the bubble film as a cushioning material absorbs impact strength which may be generated during parcel distribution, and it may replace a non-transparent plastic bag packaging. Furthermore, since the cushioning material enables the packaging to maintain its shape, clothes may be transported in the form of a hanger while being unfolded, thereby preventing creases and manufacturing the bubble film product at a cost of 40% lower than that of a known non-woven fabric suitcase.

For still another example, when a foam is used as the subsidiary material of the bubble film product, the bubble film product may be a bubble film cloth packaging material for parcel delivery services, which maintains packaging configuration (see FIG. 7D). At the time of manufacturing the cushioning material, it is possible to form a double cap, not a single cap (see FIG. 4), and therefore, surface printing is possible, and the foam constitutes a layer on the inner side so that the cushioning material and the foam absorb the impact strength which may be generated during distribution, thereby replacing all kinds of clothing packaging. Since the cushioning material and the foam enable the packaging to maintain its shape, clothes may be transported in the form of a hanger while being unfolded, thereby preventing creases and manufacturing the bubble film product at a cost of 5% to 10% lower than that of a known non-woven fabric suitcase, while ensuring anti-crease effect of clothes.

The bubble film product may be manufactured by a method of manufacturing the bubble film product 100 by laminating the adhesive layer 120, which is formed by an adhesive material, and the subsidiary material 130 on the bubble film 110. The lamination may be performed by a known method. Specifically, when the subsidiary material is the craft paper or the traditional Koran paper, the lamination may be thermal lamination. When the subsidiary material is the film, the lamination may be dry lamination. When the subsidiary material is the foam, the lamination may be cold lamination (see FIG. 5).

### Advantageous Effects of Disclosure

According to the present disclosure, provided are a bioplastic film and a bubble film capable of replacing known bubble films, wherein the bioplastic film and the bubble film may have a carbon reduction effect by using a small amount of a petroleum-derived plastic material, may be produced using the existing facility because their physical properties do not deteriorate, as compared with known petroleum-derived plastic products, and may have a unique color of wheat bran.

Further, according to the present disclosure, provided is a bubble film product which may replace known petroleum-derived bubble film products and may have buffering, insulating, and sound-proofing effects, thereby being used in a packaging material (packaging bag or packaging box), a wallpaper, a floor material, a mat (rug), a heat insulating cover, an interior material, a sculpture, and clothing (clothes, socks, hats), while reducing environmental pollution.

### BRIEF DESCRIPTION OF DRAWINGS

FIG. 1 is a flowchart illustrating a process of manufacturing a bioplastic film and a bubble film of the present disclosure;

FIG. 2 is a photograph of comparing the bubble film of the present disclosure (left) with a conventional bubble film made of polyethylene (right);

FIG. 3 is a cross-sectional view of a bubble film product of the present disclosure;

FIG. 4 is an example of the bubble film product of the present disclosure, the bubble film product being manufactured in the form of a hanger-type suitcase;

FIG. 5 illustrates a process of manufacturing the bubble film product of the present disclosure;

FIG. 6 illustrates a comparison between a cross-section of a single cap and a cross-section of a double cap; and

FIGS. 7A to 7D show photographs of bubble film products of Examples 7 to 10, in which FIG. 7A shows a bubble film product manufactured using polyethylene-coated Kraft paper as a subsidiary material, FIG. 7B shows a bubble film product manufactured using polyethylene-coated traditional Korean paper as a subsidiary material, FIG. 7C shows a bubble film product manufactured using a printed film as a subsidiary material, and FIG. 7D shows a bubble film product manufactured using a foam as a subsidiary material.

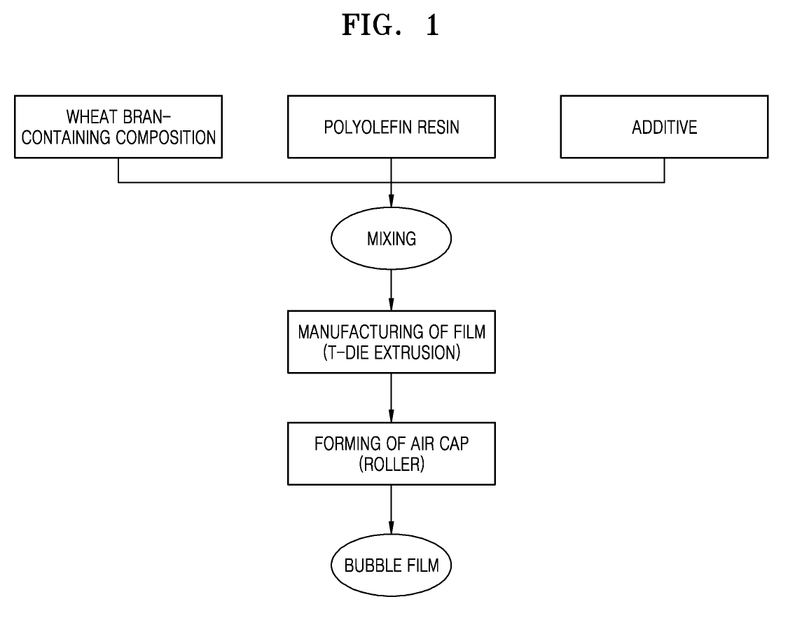

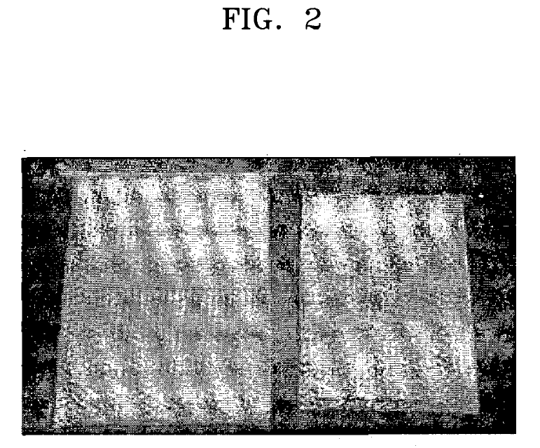

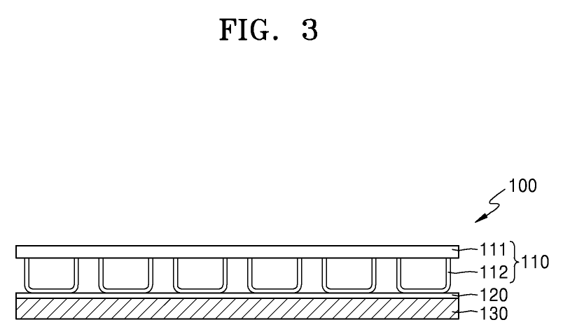

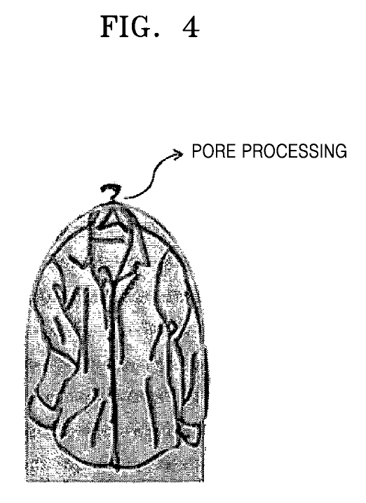

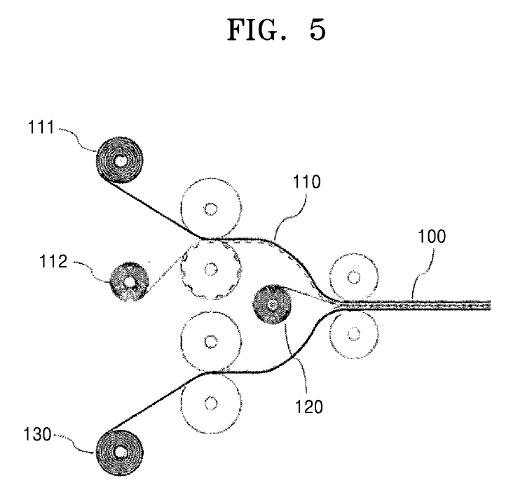

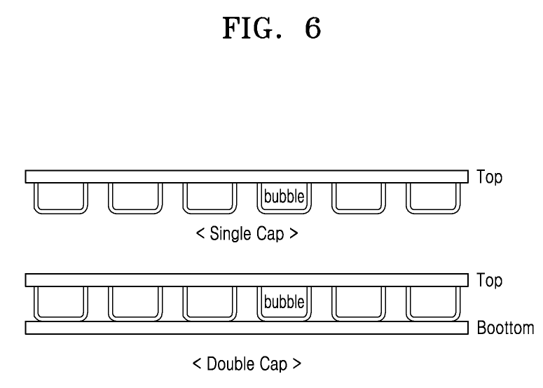

### MODE OF DISCLOSURE

Hereinafter, the present disclosure will be described in more detail with reference to the following Examples. Examples are given in terms of an embodiment of the present disclosure and not construed to limit the scope of the present disclosure.

### EXAMPLE

### 1. Examples 1 and 2: Preparation of Wheat Bran-Containing Compositions

Wheat bran was automatically dried in an ACM grinding machine with a blade motor controlled at 100 RPM to 200 RPM to a water content of 7% or below, and the grinded particles were sized-sorted to yield a powder of 15 μm and PDI=1. 15% by weight of the wheat bran powder of 15 μm and PDI=1 was mixed under heat with 60% by weight of pellet or power-type polyethylene (PE), 10% by weight of calcium carbonate as a filler, 14% by weight of wax (6% by weight of LDPE and 8% by weight of HDPE), and 1% by weight of a surfactant while the temperature was controlled at 160° C.˜200° C. not to burn the wheat bran, thereby preparing a wheat bran-containing composition of Example 1.

Further, a wheat bran-containing composition of Example 2 was prepared in the same manner as in Example 1, except that 25% by weight of wheat bran and 50% by weight of pellet or power-type polyethylene (PE) were used.

### 2. Examples 3 and 4: Manufacture of Desiccant-Containing Bioplastic Films

25% by weight of pellets which were prepared using the wheat bran-containing composition of Example 2 and 70% by weight of polyethylene (60% by weight of LLDPE and 10% by weight of LDPE) were mixed, and further mixed with 5% by weight of a desiccant based on the total weight of the mixture, and film molding was performed to manufacture a bioplastic film of Example 3.

A bioplastic film of Example 4 was manufactured in the same manner as in the bioplastic film of Example 3, except that mixing and film molding were performed without the desiccant.

### 3. Experimental Example 1: Comparison of Physical Properties of Desiccant-Containing Bioplastic Films

In order to examine applicability of bioplastic films having different desiccant contents to bubble films, their sealing strength and puncture strength were examined and results are shown in Table 1 below.

TABLE 1
Comparison of physical properties of bioplastic
films according to content of desiccant

| | Example 3 | Example 4 |
|---|---|---|
| Content of desiccant | 5% by weight | 0 |
| Sealing strength (kgf) | 0.8936 | 0.9832 |
| Puncture strength (kfg) | 0.15 | 0.1618 |

As shown in Table 1, the bioplastic film containing 5% by weight of the desiccant showed 9% reduction in sealing strength and 7.3% reduction in puncture strength, as compared with the bioplastic film containing no desiccant. However, the bioplastic film containing the desiccant of the present disclosure showed physical properties which are suitable enough to be manufactured and used as a bubble film. Thus, it was confirmed to provide a bubble film having carbon reduction and controlling the environment inside packaging materials.

### 4. Examples 5 and 6: Manufacture of Bubble Films

While the bioplastic film of Example 3 or 4 was passed through a molding roll, the bioplastic film was adhered to another bioplastic film to form a bubble film, and then cooled, thereby manufacturing a bubble film of Example 5 or 6, respectively.

### 5. Comparative Example 1: Manufacture of Existing Petroleum-Derived Bubble Films

A bubble film was manufactured in the same manner as in Example 5, after manufacturing a film by mixing 95% by weight of polyethylene and 5% by weight of the desiccant without the wheat bran-containing composition.

### 6. Experimental Example 3: Comparison of Physical Properties Between Existing Bubble Film and Bubble Film of the Present Disclosure

In order to examine whether the bubble film of the present disclosure may replace the existing petroleum-derived bubble films, sealing strength and pressure-resistant strength of the bubble films of Examples 5 and 6 and Comparative Example 1 were measured, and results are shown in Table 3.

TABLE 2
Comparison of Physical Properties between existing bubble
film and bubble films of the present disclosure

| | Comparative | | |
|---|---|---|---|
| | Example 1 | Example 5 | Example 6 |
| Sealing strength (kgf) | 2.065 | 1.721 | 1.564 |
| Pressure-resistant strength (Mpa) | 0.068 | 0.063 | 0.059 |

Sealing strength and pressure-resistant strength of the bubble films of the present disclosure were rather reduced, as compared with those of Comparative Example 1 which is the existing petroleum-derived plastic film, but the bubble films were confirmed to have the physical properties within the range applicable to bubble films.

### 7. Examples 7 to 10: Manufacture of Bubble Films Products

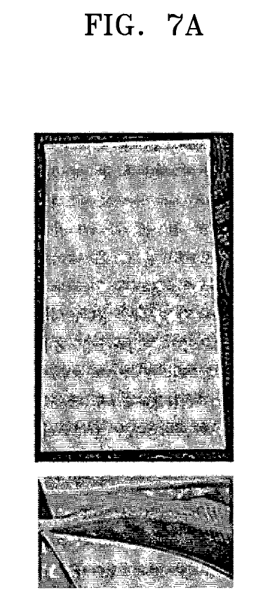

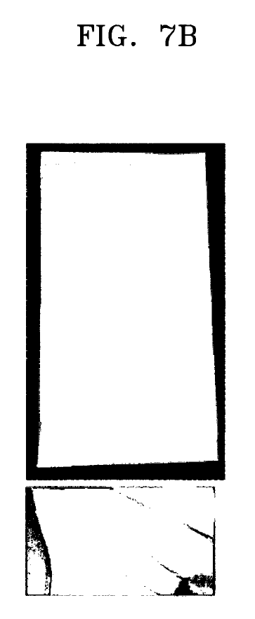

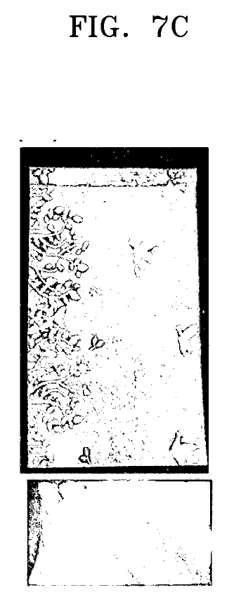

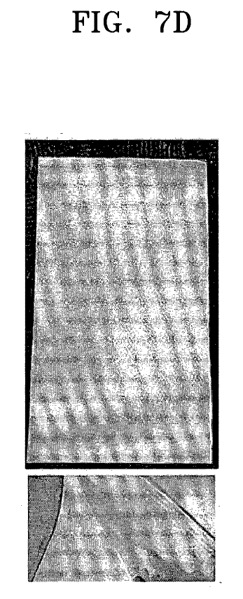

The bubble film of Example 5 was laminated with an adhesive material and a subsidiary material to manufacture a bubble film product. Specifically, thermal lamination was performed using polyethylene-coated Kraft paper or polyethylene-coated traditional Korean paper as the subsidiary material to manufacture a bubble film product of Example 7 or 8, respectively (FIGS. 7A and 7B). Dry lamination was performed using a printed film as the subsidiary material to manufacture a bubble film product of Example 9 (FIG. 7C). Cold lamination was performed using a foam as the subsidiary material to manufacture a bubble film product of Example 10 (FIG. 7D).

It was confirmed that the bubble film products of Examples 7 to 10 may be manufactured at a cost of 5% to 40% lower than that of an existing non-woven fabric suitcase, and the bubble film products may maintain a packaging shape via bubble films and may absorb impact generated during distribution.

### REFERENCE NUMERALS

100: Bubble film product
110: Bubble film
111: First bioplastic film
112: Second bioplastic film
120: Adhesive layer
130: Subsidiary material

1. A bioplastic film comprising a first polyolefin-based resin, a wheat bran-containing composition, and a desiccant.

2. The bioplastic film of claim 1, wherein the first polyolefin-based resin is one or more selected from polyethylene (PE), polypropylene (PP), polybutylene, and polymethylpentene.

3. The bioplastic film of claim 1, wherein the first polyolefin-based resin is comprised in an amount of 85% by weight to 95% by weight based on the total weight of the bioplastic film.

4. The bioplastic film of claim 1, wherein the wheat bran-containing composition is comprised in an amount of 2% by weight to 8% by weight based on the total weight of the bioplastic film.

5. The bioplastic film of claim 1, wherein the wheat bran-containing composition comprises a second polyolefin-based resin, wheat bran, a wax, an inorganic filler, and a surfactant.

6. The bioplastic film of claim 6, wherein the wheat bran has a size of 5 μm to 30 μm and a polydispersity index (PDI) of 2 or less, and is comprised in an amount of 10% by weight to 30% by weight based on the total weight of the wheat bran-containing composition.

7. The bioplastic film of claim 1, wherein the desiccant is one or more selected from zeolite, silica gel, and activated alumina.

8. The bioplastic film of claim 1, wherein the desiccant is comprised in an amount of 3% by weight to 8% by weight based on the total weight of the bioplastic film.

9. A bubble film comprising the bioplastic film of claim 1.

10. A bubble film product which is a laminate of the bubble film of claim 9 and a subsidiary material.

11. The bubble film product of claim 10, wherein the subsidiary material is one or more selected from paper, a film, a foam, and a non-woven fabric.

12. The bubble film product of claim 10, wherein the bubble film product is used in a packaging material, a wallpaper, a floor material, a mat, a heat insulating cover, an interior material, a sculpture, or clothing.
